(19) United States
(12) Patent Application Publication
(10) Pub. No.: US 2008/0299348 A1
(43) Pub. Date: Dec. 4, 2008

(54) ANTIREFLECTIVE FILM AND METHOD FOR MAKING THEREOF

(75) Inventor: Bo-Tau Liu, Douliou City (TW)

Correspondence Address: QUINTERO LAW OFFICE, PC, 2210 MAIN STREET, SUITE 200, SANTA MONICA, CA, 90405, US

(73) Assignee: Daxon Technology Inc., Taoyuan (TW)

(21) Appl. No.: 11/948,938

(22) Filed: Nov. 30, 2007

(30) Foreign Application Priority Data
May 28, 2007 (TW) TW96118948

(51) Int. Cl. B32B 27/06; B05D 1/36

(52) U.S. Cl. 428/98; 427/407.1

(57) ABSTRACT

The invention provides an antireflective film and method for making thereof. The antireflective film includes a transparent substrate with a hard coat layer thereon. A low refractive index layer having a plurality of nanoparticles is formed on the hard coat layer. The antireflective film can increase transmittance and reduce the reflectance thereof because of the nanoparticles.

### BACKGROUND OF THE INVENTION

1. Field of the Invention

The invention relates to antireflective films, and in particular relates to an antireflective film having a plurality of nanoparticles and method for making thereof.

2. Description of the Related Art

Given the rapid development and popularity of electronic devices such as 3C products, perceptions concerning antireflective films have changed from ‘expensive’ to ‘essential’. Today, antireflective films are required in variety of devices which transmit message through displays, such as computers, digital cameras, mobile phones, personal digital assistants (PDA), liquid crystal displays, and optics lenses, to assist in improving display quality.

FIG. 1 is a cross section of a conventional antireflective film. Referring to FIG. 1, a hard coat layer 12 is formed on a transparent substrate 10 followed by forming a low refractive index layer 14 thereon. When light passes through the antireflective film including materials with different refractive indices, a portion of the light is transmitted while the other portions are reflected. For the reflected light portions, reflected light waves can result in destructive interference to achieve antireflection. Generally, antireflective films with many layers, which have different refractive indices, can achieve better reflectance. Increasing the layers, however, results in raising fabrication costs and problems of mechanical strength between the layers, so that fabrication is more difficult and costly.

Thus, an antireflective film and method for making thereof ameliorating the described problems, increasing transmittance and decreasing reflectance, is needed.

### BRIEF SUMMARY OF INVENTION

Accordingly, the invention provides an antireflective film. An exemplary embodiment of the antireflective film includes a transparent substrate, a hard coat layer formed on the transparent substrate, and a low refractive index layer formed on the hard coat layer having a plurality of nanoparticles with a diameter between 10 nm and 500 nm.

Also, the invention provides a method for making an antireflective film. The method includes providing a transparent substrate and forming a hard coat layer on the transparent substrate. Then, a low refractive index layer having a plurality of nanoparticles with a diameter between 10 nm and 500 nm, is formed on the hard coat layer.

Transmittance and reflectance of antireflective film can be increased and reduced respectively because of the nanoparticles having the diameter of around 10 nm to 500 nm. Moreover, because reflectance of the antireflective film can be reduced without forming extra layers, fabrication is simplified and costs are reduced.

A detailed description is given in the following embodiments with reference to the accompanying drawings.

### BRIEF DESCRIPTION OF DRAWINGS

The invention can be more fully understood by reading the subsequent detailed description and examples with references made to the accompanying drawings, wherein:

FIG. 1 is a cross section of a conventional antireflective film;

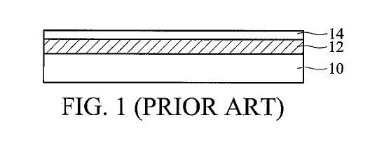

FIGS. 2A and 2B are cross sections illustrating embodiments and methods for fabricating an antireflective film; and

FIG. 3 is a cross section of an antireflective film according to another embodiment of the invention.

### DETAILED DESCRIPTION OF INVENTION

The following description is the best-contemplated mode for carrying out the invention. This description is made for the purpose of illustrating the general principles of the invention and should not be taken in a limiting sense. The scope of the invention is best determined by reference to the appended claims.

The invention will be described with respect to preferred embodiments in a specific context, namely an antireflective film and method for making thereof. The invention may also be applied, however, to other devices requiring an antireflective film. For example, the antireflective film is disposed in a display device for improving display quality.

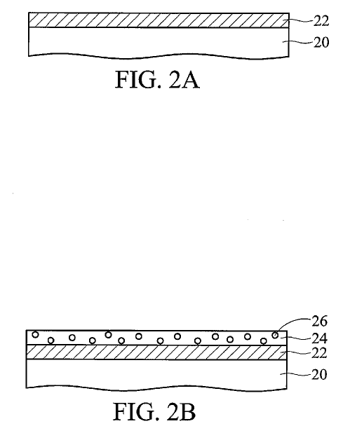

Referring to FIG. 2A, a transparent substrate 20 is provided. Preferably, the transparent substrate 20 is made of a material such as triacetyl cellulose (TAC). However, glass or polymer such as polyacrylate, polycarbonate, polyethylene, or polyethylene terephthalate may also be utilized.

Next, a solution of hard coat layer is prepared. In one embodiment, 100 parts by weight of ultraviolet curable resin is mixed with 100 parts by weight of solvent such as methyl ethyl ketone (MEK) to prepare the solution of hard coat layer, also referred to hereafter as a solution of ultraviolet curable resin. The ultraviolet curable resin may be a material of polymer including a photoinitiator, an ultraviolet curable resin monomer, and an oligomer. It is appreciated that the curing time and hardness of the ultraviolet curable resin relates to formation between the photoinitiator, the ultraviolet curable resin monomer, and the oligomer. In this example, a major purpose of the hard coat layer is to function as a supporting layer for a low refractive index layer later formed. The ultraviolet curable resin utilized to prepare the hard coat layer is only required to form a suitable hard layer. Thus, further description of the formation between the photoinitiator, the ultraviolet curable resin monomer and the oligomer is not provided.

In the embodiment, the solvent, methyl ethyl ketone, may be replaced by an organic solvent, for example, isopropyl acetone (IPA), methyl isobutyl ketone (MIBK), ethyl acetate (EAC), butyl acetate (BAC), toluene, cyclohexanone, methanol, or propylene glycol monoethyl ether acetate (PMA).

After preparation of the hard coat layer solution, the transparent substrate 20 is then coated with the hard coat layer solution. Next, the solvent is removed from the hard coat layer solution by baking. The baking is executed with an oven temperature of around 30° C. to 100° C. for 1 min to 5 mins.

Alternatively, prior to the step of coating the hard coat layer solution on the transparent substrate 20, a plurality of colloid inorganic nanoparticles or microparticles is selectively added to the hard coat layer solution to decrease shrinkage of the hard coat layer solution. The colloid inorganic nanoparticles may be a material such as silica, alumina, zironia, titania, zinc oxide, germanium oxide, indium oxide, or tin oxide. Preferably, the colloid inorganic nanoparticles have a diameter of around 10 nanometer (nm) to 50 nanometer (nm). The microparticles may be a material such as silica, alumina, acryl-styrene copolymer, melamine, or polycarbonate, and have a diameter of around 1 micrometer (μm) to 10 micrometer (μm).

After baking, the hard coat layer solution on the transparent substrate 20 is exposed by ultraviolet light with a dosage of about 500 (mJ/cm²) to form a hard coat layer 22 on the transparent substrate 20, as shown in FIG. 2A. Preferably, the hard coat layer 22 has a thickness of around 5 μm to 6 μm. It is appreciated that the thickness of hard coat layer 22 relates to the type of formation and solid content thereof. Thus, the thickness previously described is only an exemplary embodiment, is not limited thereto.

Then, the hard coat layer 22 is placed in a solution of 8% potassium hydroxide (KOH) at a temperature of about 55° C. for about 2 mins. Next, the hard coat layer 22 is baked again. Thereafter, a low refractive index layer is formed on the hard coat layer 22 to form an antireflective film.

Examples of antireflective film made and transmittance, haze and lowest reflectance of the antireflective film tested are described below.

### EXAMPLE 1

After the hard coat layer 22 has been formed, a solution of low refractive index layer was prepared. 100 parts by weight of low refractive resin was mixed with 100 parts by weight of isopropyl acetone and 100 parts by weight of methyl ethyl ketone to prepare the low refractive index solution (solution A). Next, 30 parts by weight of nanoparticles was added to the low refractive index solution (solution A) to form the low refractive index solution having a plurality of nanoparticles (solution B). 50 parts by weight of the low refractive index solution having the nanoparticles was further mixed with 80 parts by weight of methyl ethyl ketone to prepare the low refractive index solution having the nanoparticles according to Example 1.

Preferably, the low refractive index resin is a material such as fluorine-containing silane compound or fluorine-containing copolymer. In Example 1, the low refractive index resin was fluorine-containing copolymer Opstar TU2191 produced by JSR. The nanoparticles may be organic or inorganic. In the example, the organic nanoparticles may be made of a material such as poly methyl methacrylate (PMMA), polystyrene (PS), or benzoguanamine. The inorganic nanoparticles may be made of a material such as silicon oxide, aluminum oxide, antimony-doped tin oxide, tin oxide, zinc antimonite, antimony pentoxide, indium tin oxide (ITO), or aluminum-doped zinc oxide.

Meanwhile, the nanoparticles have a diameter of around 50 nm to 150 nm, preferably around 70 nm to 100 nm. Additionally, the nanoparticles preferably have a solid content of around 10% to 95%.

Next, the low refractive index layer solution having the nanoparticles has been prepared and was then formed by coating on the hard coat layer 22. A baking step, the same as the step for baking the hard coat layer 22, was executed to remove the solvent from the low refractive index layer solution. Thereafter, the low refractive index solution was exposed to ultraviolet light with a dosage of about 500 (mJ/cm²) to form a low refractive index layer 24 having a plurality of nanoparticles 26 on the hard coat layer 22, as shown in FIG. 2B.

Preferably, the low refractive index layer 24 has a thickness of around 50 nm to 200 nm. It is appreciated that the thickness of the low refractive index layer relates to the formation and the baking condition. Thus, the previously described thickness was only an exemplary embodiment and is not limited thereto.

Finally, an antireflective film according to Example 1 of the invention was fabricated. Transmittance, haze and lowest reflectance of the antireflective film according to Example 1 were measured by a U4100 spectrophotometer produced by Hitachi, and a NDH2000 Haze meter produced by Nippon Denshoku. The measured results were shown as in Table 1 below.

### COMPARATIVE EXAMPLE 1

100 parts by weight of low refractive index resin, the same as Example 1, was mixed with 100 parts by weight of isopropyl acetone and 100 parts by weight of methyl ethyl ketone to form a solution of low refractive index layer (similar to the low refractive index layer solution in Example 1). The low refractive index layer solution was coated on the hard coat layer 22 as shown in FIG. 2A. A low refractive index layer was formed on the hard coat layer by a baking step and an exposing step using ultraviolet light. An antireflective film according to Comparative Example 1 was then completed. Note that the baking and the exposing steps in Comparative Example 1 may be similar to that in Example 1.

Following formation of the low refractive layer on the hard coat layer, transmittance, haze and lowest reflectance of the antireflective film according to Comparative Example 1 were measured by the same measurement as Example 1. The measured results were shown as in Table 1 below.

### EXAMPLE 2

In Example 2, a low refractive index resin different from the resin in the Example 1, to prepare a low refractive index layer having a plurality of nanoparticles. In Example 2, the low refractive index resin was fluorine-containing copolymer LR204.33A produced by Nissan chemical.

100 parts by weight of low refractive index resin was mixed with the nanoparticles to form a low refractive index resin solution (solution C). Then, 50 parts by weight of the low refractive index resin solution was mixed with 80 parts by weight of solvent such as methyl ethyl ketone (MEK) to prepare a low refractive index layer solution.

The low refractive index layer solution was coated on the hard coat layer 22 then baked to form a low refractive index layer 24 with nanoparticles 26 on the hard coat layer 22, as shown in FIG. 2B. In an exemplary embodiment, the baking step was performed with an oven temperature of around 60° C. to 100° C. for 5 mins to 60 mins. Following the above described steps, fabrication of an antireflective film having the nanoparticles, according to Example 2, was completed.

Next, transmittance, haze and lowest reflectance of the antireflective film having the nanoparticles according to Example 2 were measured by the same measurement devices as Example 1. The measured results were shown as in Table 1 below.

### COMPARATIVE EXAMPLE 2

In Comparative Example 2, the same low refractive index resin as in Example 2 was coated on the hard coat layer 22 as shown in FIG. 2A. A baking step, the same in Example 2 was performed to form a low refractive index layer without the nanoparticles on the hard coat layer 22 to complete the antireflective film. Following the above described steps, transmittance, haze and lowest reflectance of the antireflective film according to Comparative Example 2 were measured by the same measurement devices as Example 1 and results were shown as in Table 1 below.

TABLE 1

| | | | Comparative | Comparative |
|---|---|---|---|---|
| | Example 1 | Example 2 | Example 1 | Example 2 |
| Transmittance | 95.53 | 94.08 | 94.41 | 93.21 |
| (%) | | | | |
| Haze (%) | 0.51 | 0.61 | 0.35 | 0.37 |
| The lowest | 0.12 | 0.87 | 1.34 | 1.66 |
| reflectance (%) | | | | |

As shown in Table 1, the antireflective film according to Example 1 had transmittance of about 95.53% and for Comparative Example 1, about 94.41%. Thus, the transmittance of the antireflective film having the nanoparticles was more than that of the antireflective film without the nanoparticles. Moreover, the antireflective film according to Example 1 had lowest reflectance of about 0.12% when compared to Example 1, where lowest reflectance was 1.34%. Thus, the lowest reflectance of the antireflective film having the nanoparticles was less than that of the antireflective film without nanoparticles. Accordingly, the antireflective film with the nanoparticles had relatively higher transmittance with relatively lowest reflectance.

Referring to Table 1, the antireflective film according to Example 2 had transmittance of about 94.08% and for Comparative Example 2, about 93.21%. Thus, the transmittance of the antireflective film having the nanoparticles in Example 2 was higher than the transmittance in Comparative Example 2. Moreover, in Example 2, the lowest reflectance of the antireflective film having the nanoparticles was about 0.87%. In Comparative Example 2, the lowest reflectance of the antireflective film was about 1.66%. Thus, for lowest reflectance, the antireflective film having the nanoparticles was less than the antireflective film without nanoparticles. Accordingly, the antireflective film having the nanoparticles not only had relatively higher transmittance, but also relatively lower reflectance.

In summary, the antireflective film having the nanoparticles according to the exemplary embodiments of the invention had relatively higher transmittance, as well as relatively lower reflectance. Moreover, when the nanoparticles were added, the lowest reflectance of the antireflective film was reduced to at least twice as much as the one without them. In the examples of the invention, the lowest reflectance of the antireflective films was reduced to about 10 times the ones in the comparative examples.

Note that the reflectance of the antireflective film according to the examples of the invention was reduced without forming extra layers. Thus, fabrication costs were reduced. Meanwhile, fabrication of the antireflective film having the relatively lower reflectance according to the invention was simpler.

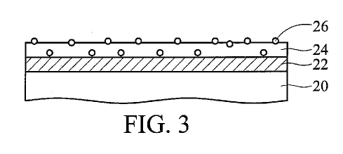

In FIG. 3, an antireflective film according to another embodiment of the invention is shown. The hard coat layer 22 is formed on the transparent substrate 20. Next, the low refractive index layer 24 having a plurality of the nanoparticles 26 is formed on the hard coat layer 22 to form an antireflective film with a rough surface. Preferably, the antireflective film has a surface roughness (Rz) less than 100 nm, so that its transmittance is increased and reflectance is reduced.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An antireflective film, comprising:
a transparent substrate;
a hard coat layer formed on the transparent substrate; and
a low refractive index layer formed on the hard coat layer and comprising a plurality of nanoparticles having a diameter between 10 nm and 500 nm, therein.

2. The antireflective film as claimed in claim 1, wherein the transparent substrate comprises glass or polymer.

3. The antireflective film as claimed in claim 2, wherein the polymer comprises polyacrylate, polycarbonate, polyethylene, polyethylene terephthalate, or triacetyl cellulose.

4. The antireflective film as claimed in claim 1, wherein the low refractive index layer comprises fluorine-containing silane compound or fluorine-containing copolymer.

5. The antireflective film as claimed in claim 1, wherein the nanoparticles comprise organic or inorganic material.

6. The antireflective film as claimed in claim 1, wherein the nanoparticles comprise silicon oxide, aluminum oxide, antimony-doped tin oxide, tin oxide, zinc antimonite, antimony pentoxide, indium tin oxide, or aluminum-doped zinc oxide.

7. The antireflective film as claimed in claim 1, wherein the nanoparticles comprise poly methyl methacrylate, polystyrene, or benzoguanamine.

8. The antireflective film as claimed in claim 1, wherein the nanoparticles have a solid content ratio of around 10% to 95%.

9. The antireflective film as claimed in claim 1, wherein the antireflective film has a surface roughness less than about 100 nm.

10. The antireflective film as claimed in claim 1, wherein the hard coat layer comprises a photoinitiator, an ultraviolet curable resin monomer, and an oligomer.

11. The antireflective film as claimed in claim 1, wherein the hard coat layer comprises a plurality of colloid inorganic nanoparticles therein.

12. The antireflective film as claimed in claim 11, wherein the colloid inorganic nanoparticles comprise silica, alumina, zirconia, titania, zinc oxide, germanium oxide, indium oxide, or tin oxide.

13. The antireflective film as claimed in claim 1, wherein the hard coat layer comprises a plurality of microparticles.

14. The antireflective film as claimed in claim 13, wherein the microparticles comprises silica, alumina, acryl-styrene copolymer, melamine, or polycarbonate.

15. A method for making an antireflective film, comprising:
providing a transparent substrate;
forming a hard coat layer on the transparent substrate; and
forming a low refractive index layer on the hard coat layer, wherein the the low refractive index layer comprises a plurality of nanoparticles having a diameter between 10 nm and 500 nm, therein.

16. The method as claimed in claim 15, wherein the low refractive index layer comprises fluorine-containing silane compound or fluorine-containing copolymer.

17. The method as claimed in claim 15, wherein the nanoparticles comprise silicon oxide, aluminum oxide, antimony-doped tin oxide, tin oxide, zinc antimonite, antimony pentoxide, indium tin oxide, or aluminum-doped zinc oxide.

18. The method as claimed in claim 15, wherein the nanoparticles comprise poly methyl methacrylate, polystyrene, or benzoguanamine.

19. The method as claimed in claim 15, wherein the hard coat layer comprises a photoinitiator, an ultraviolet curable resin monomer, an oligomer, and a solvent.

20. The method as claimed in claim 15, wherein the hard coat layer comprises a plurality of colloid inorganic nanoparticles or microparticles.
